(19) United States
(12) Patent Application Publication
(10) Pub. No.: US 2025/0233958 A1
(43) Pub. Date: Jul. 17, 2025

(54) SPARTAN: SELF-SUPERVISED SPATIOTEMPORAL TRANSFORMERS APPROACH TO GROUP ACTIVITY RECOGNITION

(71) Applicant: BOARD OF TRUSTEES OF THE UNIVERSITY OF ARKANSAS, Little Rock, AR (US)

(72) Inventors: Naga Venkata Sai Raviteja Chappa, Bentonville, AR (US); Khoa Luu, Fayetteville, AR (US)

(73) Assignee: BOARD OF TRUSTEES OF THE UNIVERSITY OF ARKANSAS, Little Rock, AR (US)

(21) Appl. No.: 19/018,976

(22) Filed: Jan. 13, 2025

Related U.S. Application Data
(60) Provisional application No. 63/620,496, filed on Jan. 12, 2024.

(51) Int. Cl. H04N 5/14; G06V 10/82

(52) U.S. Cl. CPC H04N 5/145; G06V 10/82

(57) ABSTRACT

The present disclosure pertains to a computer-implemented method of predicting one or more motions of a video by (1) generating a plurality of temporal views of the video, where the temporal views of the video include a plurality of different video clips with varying motion characteristics; (2) varying spatial characteristics of the plurality of the video clips, where the varying includes generating local spatial fields and global spatial fields of the video clips; and (3) feeding the video clips, the local spatial fields, and the global spatial fields into an algorithm, where the algorithm matches varying views of the video clips across spatial and temporal dimensions in latent space to predict the one or motions of the video. Additional embodiments pertain to computer program products and systems for predicting one or more motions of a video.

### CROSS-REFERENCE TO RELATED APPLICATIONS

This application claims priority to U.S. Provisional Patent Application No. 63/620,496, filed on Jan. 12, 2024. The entirety of the aforementioned application is incorporated herein by reference.

### STATEMENT REGARDING FEDERALLY SPONSORED RESEARCH

This invention was made with government support under OIA1946391 awarded by the National Science Foundation. The government has certain rights in the invention.

### BACKGROUND

A need exists for more effective systems and methods for GAR. Numerous embodiments of the present disclosure aim to address the aforementioned limitations.

### SUMMARY

In some embodiments, the present disclosure pertains to a computer-implemented method of predicting one or more motions of a video. In some embodiments, the methods of the present disclosure include steps of: (1) generating a plurality of temporal views of the video, where the temporal views of the video include a plurality of different video clips with varying motion characteristics; (2) varying spatial characteristics of the plurality of the video clips, where the varying includes generating local spatial fields and global spatial fields of the video clips; and (3) feeding the video clips, the local spatial fields, and the global spatial fields into an algorithm, where the algorithm matches varying views of the video clips across spatial and temporal dimensions in latent space to predict the one or motions of the video. In some embodiments, the methods of the present disclosure also include a step of generating an output of the one or more predicted motions of the video.

Additional embodiments of the present disclosure pertain to a computer program product for predicting one or more motions of a video. Further embodiments of the present disclosure pertain to systems for predicting one or more motions of a video.

### BRIEF DESCRIPTION OF THE DRAWINGS

FIG. 1 illustrates a method of predicting one or more motions of a video.

FIG. 2 illustrates a system for predicting one or more motions of a video.

FIGS. 3A-3B show visualization of attention captured by a self-supervised spatiotemporal transformers approach to group activity recognition (SPARTAN) model. FIG. 3A shows that the attention in Example 1 focuses on how the relationship is established between the actors. Included are Original sequence from NBA dataset (top), Attention captured by DFWSGAR (middle), and SPARTAN model (bottom). Dark-colored actors are the irrelevant information to determine the group activity, whereas light-colored actors, including their positions, are the most relevant. FIG. 3B illustrates that DFWSGAR predicts the category wrong due to the effects shown in FIG. 3A, whereas SPARTAN is more confident in the prediction, which is further justified by the t-SNE plot as shown in FIG. 7.

FIG. 4 shows that the proposed SPARTAN Framework samples gave input video into global and local views. The sampling strategy for video clips results in different frame rates and spatial characteristics between global views and local views, which are subject to spatial augmentations and have limited fields of view. The teacher model processes global views (gt) to generate a target, while the student model processes local views (lₜ & lₛ) where Kl≤Kg. The network weights are updated by matching the online student local views to the target teacher global views, which involves cross-view correspondences and motion correspondences. Applicant's approach utilizes a standard ViT backbone with separate space-time attention and an MLP to predict target features from online features.

FIG. 5 illustrates inference, where Applicant uniformly sampled a video clip and passed it through a shared network and generate feature vectors (class tokens). These vectors are fed to the downstream task classifier.

FIG. 6 shows visualization of the Transformer attention maps for the NBA dataset. The top panel includes an original sequence from an NBA dataset. The middle panel shows attention maps from DFWSGAR. The bottom panel shows attention maps from the SPARTAN model.

FIG. 7 shows a t-SNE visualization of feature embedding learned by different variants of Applicant's SPARTAN model in the NBA dataset.

### DETAILED DESCRIPTION

It is to be understood that both the foregoing general description and the following detailed description are illustrative and explanatory, and are not restrictive of the subject matter, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements or components comprising one unit and elements or components that include more than one unit unless specifically stated otherwise.

The section headings used herein are for organizational purposes and are not to be construed as limiting the subject matter described. All documents, or portions of documents, cited in this application, including, but not limited to, patents, patent applications, articles, books, and treatises, are hereby expressly incorporated herein by reference in their entirety for any purpose. In the event that one or more of the incorporated literature and similar materials defines a term in a manner that contradicts the definition of that term in this application, this application controls.

The goal of group activity recognition (GAR) is to classify a group of people's actions in a given video clip as a whole. GAR has gained popularity due to a wide range of applications, including sports video analysis, video monitoring, and interpretation of social settings.

Far apart from conventional action recognition methods that focus on understanding individual actions, GAR requires a thorough and exact knowledge of interactions between several actors, which poses fundamental issues such as actor localization and modeling their spatiotemporal relationships. Most existing methods for GAR require ground-truth bounding boxes of individual actors for training and testing, as well as their action class labels for training.

Despite the fact that prior GAR approaches performed admirably on difficult tasks, their reliance on bounding boxes at inference and substantial data labeling annotations makes them unworkable and severely limits their application. As such, a need exists for more effective systems and methods for GAR. Numerous embodiments of the present disclosure aim to address the aforementioned limitations.

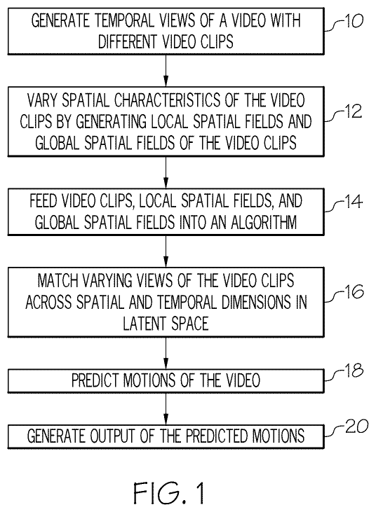

In some embodiments, the present disclosure pertains to a computer-implemented method of predicting one or more motions of a video. In some embodiments illustrated in FIG. 1, the methods of the present disclosure include steps of: generating a plurality of temporal views of the video, where the temporal views of the video include a plurality of different video clips with varying motion characteristics (step 10); varying spatial characteristics of the plurality of the video clips, where the varying includes generating local spatial fields and global spatial fields of the video clips (step 12); and feeding the video clips, the local spatial fields, and the global spatial fields into an algorithm (step 14), where the algorithm matches varying views of the video clips across spatial and temporal dimensions in latent space (step 16) to predict the one or motions of the video (step 18). In some embodiments, the methods of the present disclosure also include a step of generating an output of the one or more predicted motions of the video (step 20).

Additional embodiments of the present disclosure pertain to a computer program product for predicting one or more motions of a video. The computer program products of the present disclosure generally include one or more computer readable storage mediums having a program code embodied therewith, where the program code includes programming instructions for: (a) generating a plurality of temporal views of the video, where the temporal views of the video include a plurality of different video clips with varying motion characteristics; (b) varying spatial characteristics of the plurality of the video clips, where the varying includes generating local spatial fields and global spatial fields of the video clips; and (c) feeding the video clips, the local spatial fields, and the global spatial fields into an algorithm, where the algorithm matches varying views of the video clips across spatial and temporal dimensions in latent space to predict the one or motions of the video. In some embodiments, the program code further includes programming instructions for (d) generating an output of the one or more predicted motions of the video.

Further embodiments of the present disclosure pertain to a system that includes: a memory for storing a computer program for predicting one or more motions of a video; and a processor connected to the memory, where the processor is configured to execute the following program instructions of the computer program: (a) generating a plurality of temporal views of the video, where the temporal views of the video include a plurality of different video clips with varying motion characteristics; (b) varying spatial characteristics of the plurality of the video clips, where the varying includes generating local spatial fields and global spatial fields of the video clips; and (c) feeding the video clips, the local spatial fields, and the global spatial fields into an algorithm, where the algorithm matches varying views of the video clips across spatial and temporal dimensions in latent space to predict the one or motions of the video. In some embodiments, the processor is further configured to execute program instructions for (d) generating an output of the one or more predicted motions of the video.

### Temporal Views of a Video

The methods, computer program products, and systems of the present disclosure may utilize various temporal views of a video. For instance, in some embodiments, the temporal views of the video include a collection of video clips sampled at a certain video frame rate. In some embodiments, the temporal views include a collection of video clips with varying resolutions. In some embodiments, the temporal views include altering or different fields of view.

### Varying of Spatial Characteristics

The methods, computer program products, and systems of the present disclosure may vary spatial characteristics of video clips to generate various local spatial fields and global spatial fields. For instance, in some embodiments, local spatial fields have a smaller area than global spatial fields. In some embodiments, local spatial fields represent a localized segment of a video clip while global spatial fields represent a larger segment of the video clip, such as the entire video clip.

### Algorithms

The methods, computer program products, and systems of the present disclosure may also utilize various types of algorithms. For instance, in some embodiments, the algorithm is a loss of function algorithm. In some embodiments, the algorithm is trained to learn long-range dependencies in spatial and temporal domains of the video clips.

In some embodiments, the algorithm includes an artificial neural network. In some embodiments, the artificial neural network includes a convolutional neural network (CNN). In some embodiments, the artificial neural network includes a recurrent neural network (RNN).

In some embodiments, the computer program products of the present disclosure include the algorithm. In some embodiments, the systems of the present disclosure include the algorithm.

### Motion Prediction

The methods, computer program products, and systems of the present disclosure may predict motions of a video in various advantageous manners. For instance, in some embodiments, the prediction occurs in a self-supervised manner. In some embodiments, the prediction occurs without the use of ground-truth bounding boxes. In some embodiments, the prediction occurs without the use of labeled data sets. In some embodiments, the prediction occurs without the use of object detectors.

### Systems

The systems of the present disclosure can include various types of computer-readable storage mediums. For instance, in some embodiments, the computer-readable storage medium can be a tangible device that can retain and store instructions for use by an instruction execution device. In some embodiments, the computer-readable storage medium may include, without limitation, an electronic storage device, a magnetic storage device, an optical storage device, an electromagnetic storage device, a semiconductor storage device, or combinations thereof. A non-exhaustive list of more specific examples of suitable computer-readable storage medium includes, without limitation, a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device, or combinations thereof.

A computer-readable storage medium, as used herein, is not to be construed as being transitory signals per se. Such transitory signals may be represented by radio waves or other freely propagating electromagnetic waves, electromagnetic waves propagating through a waveguide or other transmission media (e.g., light pulses passing through a fiber-optic cable), or electrical signals transmitted through a wire.

In some embodiments, computer-readable program instructions for systems can be downloaded to respective computing/processing devices from a computer-readable storage medium or to an external computer or external storage device via a network, such as the Internet, a local area network (LAN), a wide area network (WAN) and/or a wireless network. In some embodiments, the network may include copper transmission cables, optical transmission fibers, wireless transmission, routers, firewalls, switches, gateway computers and/or edge servers. In some embodiments, a network adapter card or network interface in each computing/processing device receives computer-readable program instructions from the network and forwards the computer-readable program instructions for storage in a computer-readable storage medium within the respective computing/processing device.

In some embodiments, computer-readable program instructions for carrying out operations of the present disclosure may be assembler instructions, instruction-set-architecture (ISA) instructions, machine instructions, machine-dependent instructions, microcode, firmware instructions, state-setting data, configuration data for integrated circuitry, or either source code or object code written in any combination of one or more programming languages, including an object-oriented programming language such as Smalltalk, C++, or the like, and procedural programming languages, such as the “C” programming language or similar programming languages.

In some embodiments, the computer-readable program instructions may execute entirely on the user's computer, partly on the user's computer, as a stand-alone software package, partly on the user's computer and partly on a remote computer or entirely on the remote computer or server. In the latter scenario, the remote computer may be connected in some embodiments to the user's computer through any type of network, including a LAN or a WAN, or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry in order to perform aspects of the present disclosure.

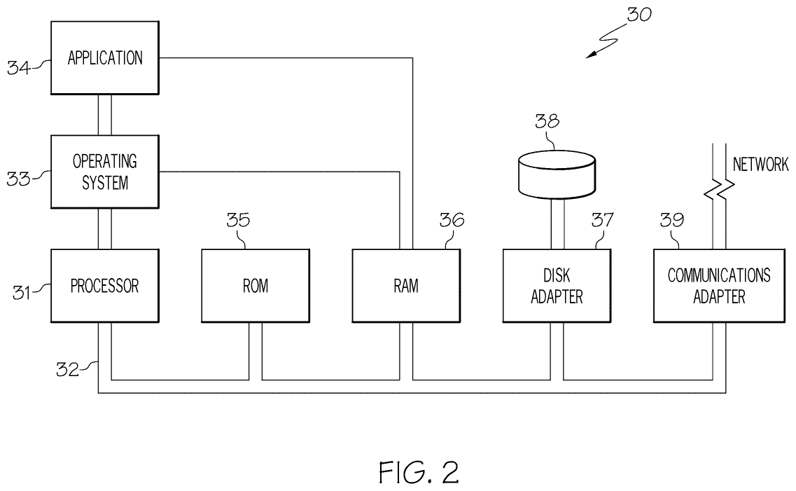

Embodiments of the present disclosure for predicting one or more motions of a video as discussed herein may be implemented using a system illustrated in FIG. 2. Referring now to FIG. 2, FIG. 2 illustrates an embodiment of the present disclosure of the hardware configuration of a system 30 which is representative of a hardware environment for practicing various embodiments of the present disclosure.

System 30 has a processor 31 connected to various other components by system bus 32. An operating system 33 runs on processor 31 and provides control and coordinates the functions of the various components of FIG. 2. An application 34 in accordance with the principles of the present disclosure runs in conjunction with operating system 33 and provides calls to operating system 33, where the calls implement the various functions or services to be performed by application 34. Application 34 may include, for example, a program for predicting one or more motions of a video as discussed in the present disclosure, such as in connection with FIGS. 1, 3A-3B, and 4-7.

Referring again to FIG. 2, read-only memory (“ROM”) 35 is connected to system bus 32 and includes a basic input/output system (“BIOS”) that controls certain basic functions of system 30. Random access memory (“RAM”) 36 and disk adapter 37 are also connected to system bus 32. It should be noted that software components including operating system 33 and application 34 may be loaded into RAM 36, which may be system's 30 main memory for execution. Disk adapter 37 may be an integrated drive electronics (“IDE”) adapter that communicates with a disk unit 38 (e.g., a disk drive). It is noted that the program for predicting one or more motions of a video, as discussed in the present disclosure, such as in connection with FIGS. 1, 3A-3B, and 4-7, may reside in disk unit 38 or in application 34.

System 30 may further include a communications adapter 39 connected to system bus 32. Communications adapter 39 interconnects system bus 32 with an outside network (e.g., wide area network) to communicate with other devices.

Aspects of the present invention are described herein with reference to flowchart illustrations and/or block diagrams of methods, apparatus (systems), and systems according to embodiments of the invention. It will be understood that each block of the flowchart illustrations and/or block diagrams and combinations of blocks in the flowchart illustrations and/or block diagrams can be implemented by computer-readable program instructions.

These computer-readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein includes an article of manufacture including instructions which implement aspects of the function/act specified in the flowchart and/or block diagram block or blocks. The computer-readable program instructions may also be loaded onto a computer, other programmable data processing apparatus, or other device to cause a series of operational steps to be performed on the computer, other programmable apparatus or other device to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and systems according to various embodiments of the present disclosure. In this regard, each block in the flowchart or block diagrams may represent a module, segment, or portion of instructions, which includes one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

### Applications and Advantages

The methods, computer program products and systems of the present disclosure provide numerous advantages. In particular, most existing methods for group activity recognition (GAR) require ground-truth bounding boxes of individual actors for training and testing, as well as their action class labels for training. However, such approaches rely on bounding boxes at inference and substantial data labeling annotations, which render them unworkable and severely limit their application.

On the other hand, in some embodiments, the methods, computer program products, and systems of the present disclosure provide a convenient and effective self-supervised spatiotemporal transformer approach to the task of group activity recognition that is independent of ground-truth bounding boxes, labels during pre-training, and object detectors (all of which other GAR programs still depend on). For instance, in some embodiments, the methods, computer program products, and systems of the present disclosure may not require ground-truth bounding boxes of individual actors for training and testing GAR programs. In some embodiments, the methods, computer program products, and systems of the present disclosure generate actor box suggestions using a detector that has been pre-trained on an external dataset in order to solve the absence of a bounding box label. In some embodiments, the methods, computer program products, and systems of the present disclosure eliminate irrelevant possibilities. In some embodiments, self-attention mechanisms in video transformers can capture local and global long-range dependencies in both space and time, offering much larger receptive fields compared to standard convolutional kernels.

As such, the methods, computer program products, and systems of the present disclosure may have various advantageous applications. For instance, in some embodiments, the methods, computer program products, and systems of the present disclosure may be utilized for group activity recognition (GAR), video analysis, video monitoring, interpretation of social settings, training, sport-related training, or combinations thereof. In some embodiments, the methods, computer program products, and systems of the present disclosure may be utilized in sports video analysis. In some embodiments, the methods, computer program products, and systems of the present disclosure may be utilized in video monitoring. In some embodiments, the methods, computer program products, and systems of the present disclosure may be utilized interpretation of social situations.

### Additional Embodiments

Reference will now be made to more specific embodiments of the present disclosure and experimental results that provide support for such embodiments. However, Applicant notes that the disclosure below is for illustrative purposes only and is not intended to limit the scope of the claimed subject matter in any way.

### Example 1. SPARTAN: Self-supervised Spatiotemporal Transformers Approach to Group Activity Recognition

In this Example, Applicant presents a new, convenient, and effective self-supervised spatio-temporal transformers (SPARTAN) approach to Group Activity Recognition (GAR) using unlabeled video data. Given a video, Applicant creates local and global spatio-temporal views with varying spatial patch sizes and frame rates. The proposed self-supervised objective aims to match the features of these contrasting views representing the same video to be consistent with the variations in spatiotemporal domains. To the best of Applicant's knowledge, the proposed mechanism is one of the first works to alleviate the weakly supervised setting of GAR using the encoders in video transformers. Furthermore, using the advantage of transformer models, Applicant's proposed approach supports long-term relationship modeling along spatio-temporal dimensions. The proposed SPARTAN approach performs well on two group activity recognition benchmarks, including NBA and Volleyball datasets, by surpassing the state-of-the-art results by a significant margin in terms of MCA and MPCA metrics.

Group Activity Recognition (GAR) aims to classify the collective actions of individuals in a video clip. This field has gained significant attention due to its diverse applications, such as sports video analysis, video monitoring, and interpretation of social situations. Far apart from conventional action recognition methods that focus on understanding individual actions, GAR requires a thorough and exact knowledge of interactions between several actors, which poses fundamental challenges such as actor localization and modelling their spatiotemporal relationships.

Most existing methods for GAR require ground-truth bounding boxes of individual actors for training and testing, as well as their action class labels for training. The bounding box labels, in particular, are used to extract features of individual actors, such as RolPool and RolAlign, and precisely discover their spatio-temporal relations. Such actor features are aggregated while considering the relationships between actors to form a group-level video representation, which is then fed to a group activity classifier.

Despite the fact that these approaches performed admirably on the difficult task, their reliance on bounding boxes at inference and substantial data labelling annotations makes them unworkable and severely limits their application. To overcome this problem, one approach is to simultaneously train person detection and group activity recognition using bounding box labels. This method estimates the bounding boxes of actors in inference. However, this method calls for individual actor ground-truth bounding boxes for training videos.

A group recently presented a Weakly Supervised GAR (WSGAR) learning approach, which does not need actor-level labels in both training and inference, to further lower the annotation cost. European Conference on Computer Vision, pages 208-224. Springer, 2020. The group generated actor box suggestions using a detector that has been pre-trained on an external dataset in order to solve the absence of bounding box labels. They then learn to eliminate irrelevant possibilities.

Recently, another group introduced a detector-free method for WSGAR task which captures the actor information using partial contexts of the token embeddings. Kim et al., Detector-free weakly supervised group activity recognition. In Proceedings of the IEEE/CVF Conference on Computer Vision and Pattern Recognition, pages 20083-20093, 2022. However, the previous methods have various drawbacks as follows.

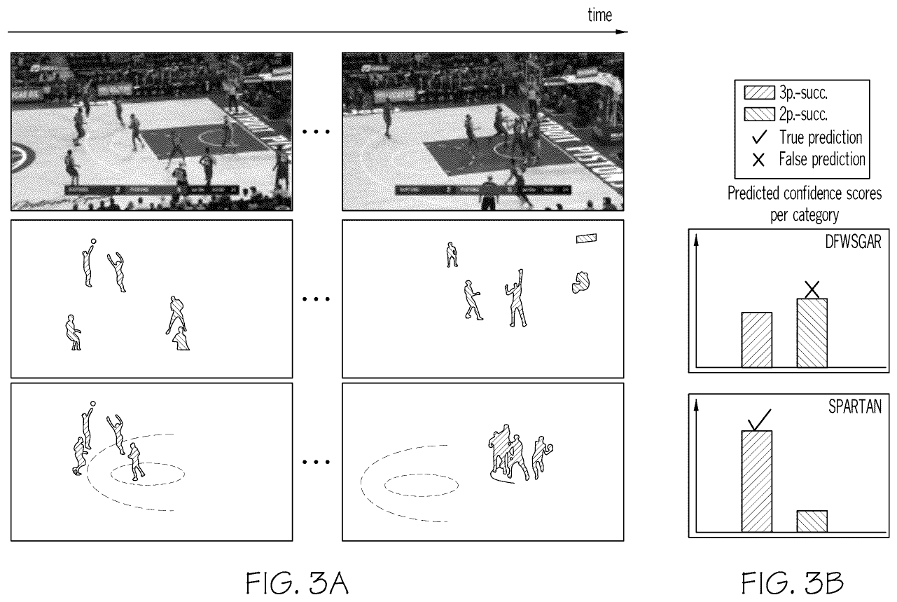

First, a detector often leads to missing detection of people in case of occlusion, which minimizes overall accuracy. Second, partial contexts can only learn if and only if there is movement in consecutive frames. This can be inferred from the illustration in FIGS. 3A-3B. Third, the temporal information among the tokens must be consistent, and the prior studies do not consider different tokens.

In this Example, Applicant introduces a new simple but effective Self-Supervised Spatio-temporal Transformers (SPARTAN) approach to the task of Group Action Recognition that is independent of ground-truth bounding boxes, labels during pre-training, and object detector. Applicant's mechanism only exploits the motion as a supervisory signal from the RGB data modality.

As seen in FIG. 3A, Applicant's model captures not only the key actors but also their positions, which shows that Applicant's method is more effective in group activity classification than DFWSGAR. Applicant's approach is designed to benefit from varying spatial and temporal details within the same deep network.

Applicant utilizes a video transformer based approach to handle varying temporal resolutions within the same architecture. Furthermore, the self-attention mechanism in video transformers can capture local and global long-range dependencies in both space and time, offering much larger receptive fields compared to standard convolutional kernels.

The contributions of this Example can be summarized as follows. First, instead of considering only motion features across consecutive frames, Applicant introduces the first training approach to GAR by exploiting spatial-temporal correspondences. The proposed method varies the spacetime features of the inputs to learn long-range dependencies in spatial and temporal domains.

Second, a new self-supervised learning strategy is performed by jointly learning the inter-frame (i.e., frame-level temporal) and intra-frame (i.e., patch-level spatial) correspondences further forming into Inter Teacher-Inter Student loss and Inter Teacher-Intra Student loss. In particular, the spatiotemporal features global, from the entire sequence, and local from the sampled sequence are matched by the learning objectives of the frame level and the patch level in the latent space. With extensive experiments on NBA and Volleyball datasets, the proposed method shows the State-of-the-Art (SOTA) performance results using only RGB inputs.

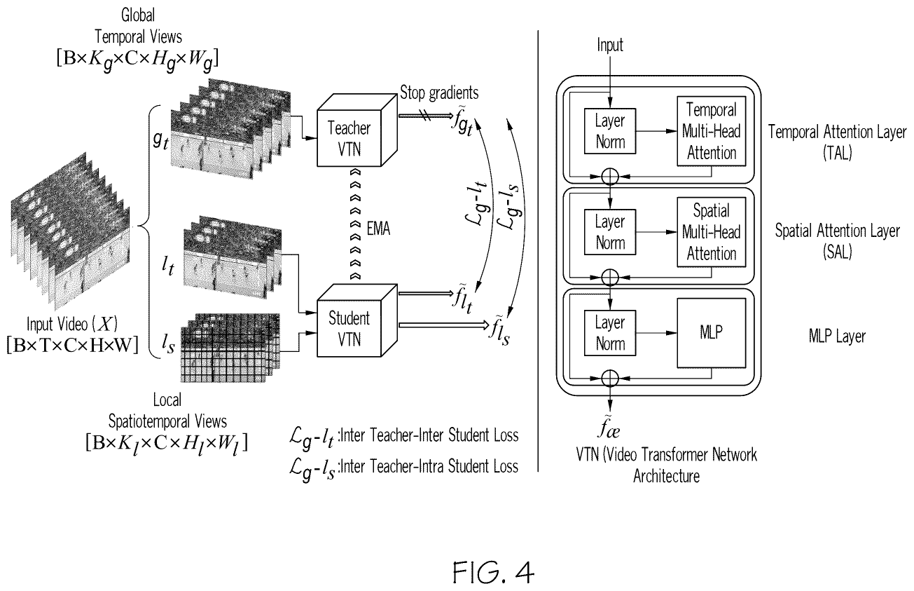

This Example aims to recognize a group activity in a given video without using person-bounding boxes or a detector. The general architecture of Applicant's self-supervised training within the teacher-student framework for group activity recognition is illustrated in FIG. 4. Unlike the other contrastive learning methods, Applicant processes two clips from the same video by changing their spatial-temporal characteristics, which do not rely on the memory banks. The proposed loss formulation matches the features of the two dissimilar clips to impose consistency in motion and spatial changes in the same video. The proposed SPARTAN framework will be discussed further in the following sections.

### Example 1.1. Self-Supervised Training

Given the high temporal dimensionality of videos, motion and spatial characteristics of the group activity will be learned, such as 3p.-succ. (from NBA dataset) or Ispike (from Volleyball dataset) during the video. Thus, several video clips with different motion characteristics can be sampled from a single video. A key novelty of the proposed approach involves predicting these different video clips with varying temporal characteristics from each other in the feature space. It leads to learning contextual information that defines the underlying distribution of videos and makes the network invariant to motion, scale, and viewpoint variations. Thus, self-supervision for video representation learning is formulated as a motion prediction problem that has three key components: a) Applicant generates multiple temporal views consisting of different numbers of clips with varying motion characteristics from the same video; b) In addition to motion, Applicant can vary spatial characteristics of these views as well by generating local (i.e., smaller spatial field) and global (i.e., higher spatial field) of the sampled clips; and c) Applicant can introduce a loss function that matches the varying views across spatial and temporal dimensions in the latent space.

### Example 1.2. Motion Prediction as Self-Supervision Learning

The frame rate is a crucial aspect of a video as it can significantly alter the motion context of the content. For instance, the frame rate can affect the perception of actions, such as walking slowly versus walking quickly, and can capture subtle nuances, such as the slight body movements in walking. Traditionally, video clips are sampled at a fixed frame rate. However, when comparing views with different frame rates (i.e., varying numbers of clips), predicting one view from another in feature space requires explicitly modeling object motion across clips. Furthermore, predicting subtle movements captured at high frame rates compels the model to learn contextual information about motion from a low frame rate input.

### Example 1.3. Temporal Views

Temporal views refer to a collection of video clips sampled at a specific video frame rate. Applicant generated different views by sampling at different frame rates, producing temporal views with varying resolutions. The number of temporal tokens (T) input to ViT varies in different views. Applicant's proposed method enforces the correspondences between such views, which allows for capturing different motion characteristics of the same action. Applicant randomly sampled these views to create motion differences among them.

The ViT models process these views, and Applicant predicted one view from the other in the latent space. In addition to varying temporal resolution, Applicant also varied the resolution of clips across the spatial dimension within these views. It means that the spatial size of a clip can be lower than the maximum spatial size, which can also decrease the number of spatial tokens. Similar sampling strategies have been used but under multi-network settings, while Applicant's approach handles such variability in temporal resolutions with a single ViT model by using vanilla positional encoding.

### Example 1.4. Cross-View Correspondences

Applicant's training strategy aims to learn the relationships between a given video's temporal and spatial dimensions. To this end, Applicant proposes novel cross-view correspondences by altering the field of view during sampling. Applicant generated global and local temporal views from a given video to achieve this.

### Example 1.4.1. Global Temporal Views (gt)

Applicant randomly sampled Kg (is equal to T) frames from a video clip with spatial size fixed to W_{global} and H_{global}. These views are fed into the teacher network which yields an output denoted by ^{˜}fgt.

### Example 1.4.2. Local Spatiotemporal Views (lt and ls)

Local views cover a limited portion of the video along both spatial and temporal dimensions. Applicant generated local temporal views by randomly sampling several frames Kl (≤Kg) with a spatial size fixed to W_{local} and H_{local}. These views are fed into the student network, which yields two outputs denoted by ^{˜}flt and ^{˜}fls, respectively.

### Example 1.4.3. Augmentations

Applicant applied different data augmentation techniques to the spatial dimension, that is, to the clips sampled for each view. Specifically, Applicant applied color jittering and gray scaling with probability 0.8 and 0.2, respectively, to all temporal views. Applicant applied Gaussian blur and solarization with probability of 0.1 and 0.2, respectively, to global temporal views.

Applicant's approach is based on the intuition that learning to predict a global temporal view of a video from a local temporal view in the latent space can help the model capture high-level contextual information. Specifically, Applicant's method encourages the model to model both spatial and temporal context, where the spatial context refers to the possibilities surrounding a given spatial crop and the temporal context refers to possible previous or future clips from a given temporal crop.

It is important to note that spatial correspondences also involve a temporal component, as Applicant's approach attempts to predict a global view at timestamp t=j from a local view at timestamp t=i. To enforce these cross-view correspondences, Applicant uses a similarity objective that predicts different views from each other.

### Example 1.5. The Proposed Objective Function

Applicant's model is trained with an objective function that predicts different views from each other. These views represent different spatial-temporal variations that belong to the same video.

Given a video X={xt}ₜ₌₁^{T}, where T represents the number of frames, let gₜ, lₜ and lₛ represent global temporal views, local temporal and spatial views such that gₜ={xₜ}^{Kg}ₜ₌₁, and lₜ=lₛ={xt}^{Kl}ₜ₌₁, where gₜ, lₜ and lₛ are subsets of video X and Kₗ≤K_{g} where K_{g} and Kₗ are the number of frames for teacher and student (global and local) inputs.

Applicant randomly sampled K_{g} global and Kₗ local temporal views. These temporal views are passed through the student and teacher models to get the corresponding class tokens or feature f_{g} and fₗ. These class tokens are normalized as follows in Equation 1.

$${\tilde{f}}^{( i )} = \frac{exp ( {f}^{( i )} ) / τ}{{\sum }_{i = 1}^{n} exp ( {f}^{( i )} ) / τ} \qquad Equation 1$$

In Equation 1, τ is a temperature parameter used to control the sharpness of the exponential function and f⁽ⁱ⁾ is each element in ^{˜}f⁽ⁱ⁾∈Rn.

### Example 1.5.1. Inter Teacher-Inter Student Loss

Applicant's gₜ have the same spatial size but differ in temporal content because the number of clips/frames is randomly sampled for each view. One of the gₜ always passes through the teacher model that serves as the target label. Applicant maps the student's lₜ with the teacher's gₜ to create a global-to-local temporal loss as in Equation 2.

$${ℒ}_{{g}_{t} - {l}_{t}} = - {\tilde{f}}_{{g}_{t}} * log ( {\tilde{f}}_{{l}_{t}} ) \qquad Equation 2$$

In Equation 2, f_{gt} and fₗₜ are the tokens of the class for g; and lₜ produced by the teacher and student, respectively.

### Example 1.5.2. Inter Teacher-Intra Student Loss

Applicant's lₜ has a limited field of vision along the spatial and temporal dimensions compared to the gₜ. However, the number of local views is four times higher than that of global views. All lₛ are passed through the student model and mapped to gₜ from the teacher model to create the loss function as in Equation 3.

$${ℒ}_{{g}_{t} - {l}_{s}} = {\sum }_{n = 1}^{q} - {\tilde{f}}_{{g}_{t}} * log ( {\tilde{f}}_{{l}_{s}}^{( n )} ) \qquad Equation 3$$

In Equation 3, fₗₛ are the tokens of the class for lₛ produced by the student and q represents the number of local temporal views set to sixteen in all the experiments. The overall loss to train the model is a linear combination of both losses, as in Equations 2 and 3, and given as in Equation 4.

$$ℒ = {ℒ}_{{g}_{t} - {l}_{t}} + {ℒ}_{{g}_{t} - {l}_{s}} \qquad Equation 4$$

### Example 1.6. Inference

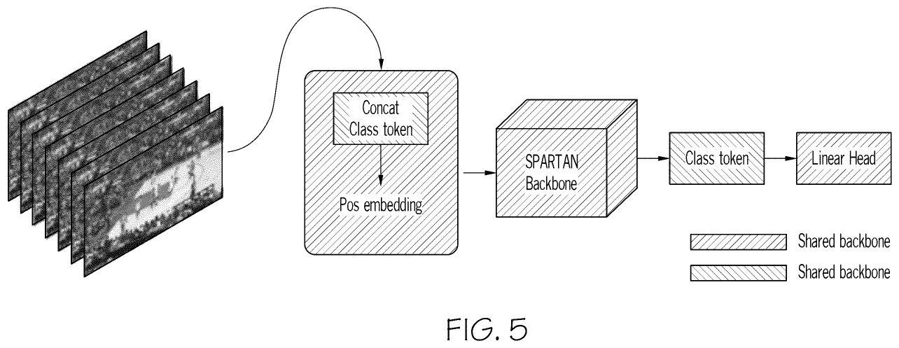

FIG. 5 illustrates the inference framework. During this stage, fine-tuning of the trained self-supervised model is performed. Applicant used the pre-trained SPARTAN model and fine-tuned the model with the available labels, followed by a linear classifier. Applicant used this on downstream tasks to improve performance.

### Example 1.7. Datasets

Volleyball datasets include 3,493 training and 1,337 testing clips, totaling 4,830 labeled clips, from 55 videos. The dataset contains annotations for eight group activity categories and nine individual action labels with corresponding bounding boxes. However, in Applicant's WSGAR experiments, Applicant only used the group activity labels and ignored the individual action annotations. For evaluation, Applicant used Multi-class Classification Accuracy (MCA) and Merged MCA metrics, where the latter merges the right set and right pass classes into right pass-set and the left set and left pass classes into left pass-set, as in previous works such as SAM and DFWSGAR. This is done to ensure a fair comparison with existing methods.

NBA Dataset in Applicant's experiment includes a total of 9,172 labeled clips from 181 NBA videos, with 7,624 clips used for training and 1,548 for testing. Each clip is annotated with one of nine group activities, but there is no information on individual actions or bounding boxes. In evaluating the model, Applicant used the Multi-class Classification Accuracy (MCA) and Mean Per Class Accuracy (MPCA) metrics, with MPCA used to address the issue of class imbalance in the dataset.

### Example 1.8. Deep Network Architecture

Applicant's video processing approach uses a vision transformer (ViT) to apply individual attention to both the temporal and spatial dimensions of the input video clips. The ViT consists of 12 encoder blocks and can process video clips of size (B×T×C×W×H), where B and C represent the batch size and the number of color channels, respectively. The maximum spatial and temporal sizes are W=H=224 and T=18, respectively, meaning that Applicant samples 18 frames from each video and rescale them to 224×224. Applicant's network architecture (FIG. 4) is designed to handle variable input resolution during training, such as differences in frame rate, number of frames in a video clip, and spatial size. However, each ViT encoder block processes a maximum of 196 spatial and 16 temporal tokens, and each token has an embedding dimension of Rm.

Along with these spatial and temporal input tokens, Applicant also uses a single classification token as a characteristic vector within the architecture. This classification token represents the standard features learned by the ViT along the spatial and temporal dimensions of a given video. During training, Applicant uses variable spatial and temporal resolutions that are W≤224, H≤224, and T≤18, which result in various spatial and temporal tokens. Finally, Applicant applies a projection head to the class token of the final ViT encoder.

### Example 1.8.1. Self-Distillation

In Applicant's approach (shown in FIG. 4), Applicant adopts a teacher-student setup for self-distillation. The teacher model has the same architecture as the student model, including the ViT backbone and predictor MLP, but it does not undergo direct training. Instead, during each training step of the student model, Applicant updates the teacher weights using an exponential moving average (EMA) of the student weights. This approach enables Applicant to use a single shared network to process multiple input clips.

### Example 1.9. Implementation Details

For both the NBA and Volleyball datasets, frames are sampled at a rate of T (K_{g}) using segment-based sampling. The frames are then resized to W_{g}=224 and H_{g}=224 for the teacher input and Wₗ=96 and Hₗ=96 for the student input, respectively. For the Volleyball dataset, Applicant uses K_{g}=5 (Kₗ∈3, 5), while for the NBA dataset, Applicant uses K_{g}=18 (Kₗ∈2, 4, 8, 16, 18). Applicant randomly initialized weights relevant to temporal attention, while spatial attention weights are initialized using a ViT model trained self-supervised over ImageNet-1K. This initialization setup allows Applicant to achieve faster convergence of space-time ViT similar to the supervised setting.

Applicant uses an Adam optimizer with a learning rate of 5×10⁻⁴, scaled using a cosine schedule with a linear warm-up for five epochs. Applicant also used weight decay scaled from 0.04 to 0.1 during training. For the downstream task, Applicant trained a linear classifier on our pretrained SPARTAN backbone. During training, the backbone is frozen, and the classifier is trained for 100 epochs with a batch size of 32 on a single NVIDIAV100 GPU using SGD with an initial learning rate of 1e-3 and a cosine decay schedule. Applicant also set the momentum to 0.9.

### Example 1.10. Comparison with State-of-the-Art Methods

For the NBA dataset, Applicant compared this Example's approach to the state-of-the art in GAR and WSGAR, which leverage bounding box recommendations produced by SAM, as well as to current video backbones in the weakly supervised learning environment, using the NBA dataset. Applicant exclusively utilized RGB frames as input for each approach, including the video backbones, to ensure a fair comparison. Table 1 lists the findings.

TABLE 1
Comparisons with the State-of-the-Art GAR models
and video backbones on the NBA dataset.

| | | |
|---|---|---|
| Method | MCA | MPCA |

Video backbone

| | | |
|---|---|---|
| TSM | 66.6 | 60.3 |
| VideoSwin | 64.3 | 60.6 |

GAR model

| | | |
|---|---|---|
| ARG | 59.0 | 56.8 |
| AT | 47.1 | 41.5 |
| SACRF | 56.3 | 52.8 |
| DIN | 61.6 | 56.0 |
| SAM | 54.3 | 51.5 |
| DFWSGAR | 75.8 | 71.2 |
| This Example's Method | 82.1 | 72.8 |

With 6.3% p of MCA and 1.6% p of MPCA, the proposed method outperforms existing GAR and WSGAR methods by a significant margin. Additionally, Applicant's approach is contrasted with two current video backbones utilized in traditional action detection, ResNet-18 TSM and VideoSwin-T. These strong backbones perform well in WSGAR, but Applicant's method is the most optimal.

For the volleyball dataset, Applicant compared this Example's approach to the most recent GAR and WSGAR approaches in two different supervision levels: fully supervised and weakly supervised. The usage of actor-level labels, such as individual action class labels and ground-truth bounding boxes, in training and inference differs across the two settings.

For a fair comparison, Applicant reported the results of previous methods using only the RGB input, and the reproduced results using the ResNet-18 backbone. Note that the first is from the original papers, and the second is the MCA values. Applicant eliminated the individual action classification head and substituted an object detector trained on an external dataset for the ground-truth bounding boxes in the weakly supervised situation. Table 2 presents the results.

TABLE 2
Comparison with the state-of-the-art
methods on the Volleyball dataset.

| | | | |
|---|---|---|---|
| Method | Backbone | MCA | Merged MCA |

Fully supervised

| | | | |
|---|---|---|---|
| SSU | Inception-v3 | 89.9 | — |
| PCTDM | ResNet-18 | 90.3 | 94.3 |
| StagNet | VGG-16 | 89.3 | — |
| ARG | ResNet-18 | 91.1 | 95.1 |
| CRM | I3D | 92.1 | — |
| HiGCIN | ResNet-18 | 91.4 | — |
| AT | ResNet-18 | 90.0 | 94.0 |
| SACRF | ResNet-18 | 90.7 | 92.7 |
| DIN | ResNet-18 | 93.1 | 95.6 |
| TCE + STBiP | VGG-16 | 94.1 | — |
| GroupFormer | Inception-v3 | 94.1 | — |

Weakly supervised

| | | | |
|---|---|---|---|
| PCTDM | ResNet-18 | 80.5 | 90.0 |
| ARG | ResNet-18 | 87.4 | 92.9 |
| AT | ResNet-18 | 84.3 | 89.6 |
| SACRF | ResNet-18 | 83.3 | 86.1 |
| DIN | ResNet-18 | 86.5 | 93.1 |
| SAM | ResNet-18 | 86.3 | 93.1 |
| DFWSGAR | ResNet-18 | 90.5 | 94.4 |
| This Example | ViT-Base | 92.9 | 95.6 |

In weakly supervised conditions, Applicant's technique significantly outperforms all GAR and WSGAR models, outperforming them by 2.4% of MCA and 1.2% of Merged MCA when compared to the models' utilising ViT-Base backbone. Applicant's technique outperforms current GAR methods, such as by employing more thorough actor-level supervision.

### Example 1.11. Ablation Study

Applicant performed a comprehensive analysis of the different components that contribute to the effectiveness of the method in this Example. Specifically, Applicant evaluated the impact of five individual elements: a) various combinations of local and global view correspondences; b) different field of view variations along the temporal and spatial dimensions; c) the choice of temporal sampling strategy; d) the use of spatial augmentations; and e) the inference approach.

### Example 1.11.1. View Correspondences

Applicant proposes cross-view correspondences (VC) to learn correspondences between local and global views. To investigate the effect of predicting each type of view from the other, Applicant conduct experiments presented in Table 3.

TABLE 3
View Correspondences (VC). The most optimal combination
for predicting view correspondences involves predicting
local-to-global (temporal) and local-to-global (spatial)
views, outperforming other combinations.

| lₜ → gₜ | lₛ → gₜ | lₛ → lₜ | gₜ→ lₜ | NBA | Volleyball |
|---|---|---|---|---|---|
| + | − | − | − | 61.03 | 62.70 |
| − | + | − | − | 62.59 | 65.40 |
| + | + | − | − | 81.20 | 90.80 |
| + | + | + | − | 72.11 | 77.62 |
| + | + | − | + | 78.17 | 85.88 |
| − | − | + | + | 64.36 | 71.87 |

Applicant's results show that jointly predicting lₜ→gₜ and lₛ→gₜ view correspondences leads to optimal performance. However, predicting gₜ→lₜ or lₛ→lₜ views results in reduced performance, possibly because joint prediction emphasizes learning rich context, which is absent for individual cases.

Applicant also observes a consistent performance drop for lₛ→lₜ correspondences (no overlap views), consistent with previous findings on the effectiveness of temporally closer positive views for contrastive self-supervised losses.

### Example 1.11.2. Spatial Vs. Temporal Field of View

Applicant determined the optimal combination of spatio-temporal views in Table 3 by varying the field of view (crops) along both spatial and temporal dimensions. To evaluate the effects of variations along these dimensions, Applicant conducted experiments as presented in Table 4.

TABLE 4
Spatial vs Temporal variations. The best results are achieved
by utilizing cross-view correspondences with varying fields of
view along both spatial and temporal dimensions. It is observed
that temporal variations between views have a greater impact
on performance compared to applying only spatial variation.

| Spatial | Temporal | NBA | Volleyball |
|---|---|---|---|
| + | − | 69.38 | 78.59 |
| − | + | 72.90 | 81.45 |
| + | + | 81.20 | 90.80 |

Specifically, Applicant compared the performance of their approach with no variation along the spatial dimension (where all frames have a fixed spatial resolution of 224×224 with no spatial cropping) and with no variation along the temporal dimension (where all frames in Applicant's views are sampled from a fixed time-axis region of a video). Applicant's findings show that temporal variations have a significant impact on NBA, while variations in the field of view along both spatial and temporal dimensions lead to the best performance (as shown in Table 4).

### Example 1.11.3. Temporal Sampling Strategy

Applicant's investigation examines the possibility of replacing the temporal sampling strategy for motion correspondences (MC) proposed in this Example with alternate sampling methods. To evaluate the effectiveness of MC, Applicant replaced it with an alternative approach within SPARTAN. Specifically, Applicant tested the temporal interval sampling (TIS) strategy introduced previously, which has achieved state-of-the-art performance in self-supervised contrastive video settings with CNN backbones. Applicant's experiments incorporating TIS in SPARTAN (Table 5) demonstrates that Applicant's MC sampling strategy offers superior performance compared to TIS.

TABLE 5
Temporal Sampling Strategy. Applicant evaluated the effectiveness
of the proposed temporal sampling strategy, called “motion
correspondences (MC)”, by comparing it with an alternate
approach, the “temporal interval sampler (TIS)”, used
with CNNs under contrastive settings.

| Method | NBA | Volleyball |
|---|---|---|
| Applicant's + TIS | 78.45 | 88.11 |
| Applicant's + MC | 81.20 | 90.80 |

### Example 1.11.4. Spatial Augmentations

Next, Applicant investigated the impact of standard spatial augmentations (SA) on video data by experimenting with different patch sizes. Previous studies have shown that varying patch sizes can enhance the performance of CNN-based video self-supervision approaches. In this Example, Applicant evaluated the effect of patch size on their approach and present the results in Table 6, indicating that a patch size of 16 yields the best improvements.

TABLE 6
Spatial Augmentations (SA): Applying different patch sizes randomly
over the spatial dimensions for different views leads to consistent
improvements on both NBA and Volleyball datasets.

| Patch size | NBA | Volleyball |
|---|---|---|
| 8 | 78.71 | 87.10 |
| 16 | 81.20 | 90.80 |
| 32 | 72.56 | 79.21 |

Based on these findings, Applicant incorporated a patch size of 16 in the SPARTAN training process.

### Example 1.11.5. Inference

To assess the impact of Applicant's proposed inference method, Applicant analyzed the results presented in Table 7.

TABLE 7
Inference: Providing multiple views of different spatiotemporal
resolutions to a shared network (multiview) leads to noticeable
performance improvements compared to using a single view
for both the NBA and Volleyball datasets.

| Multi-view | NBA | Volleyball |
|---|---|---|
| − | 76.17 | 88.35 |
| + | 81.20 | 90.80 |

Applicant's findings demonstrate that their approach yields greater improvements on the NBA and Volleyball datasets, which contain classes that can be more easily distinguished using motion information.

### Example 1.12. Qualitative Results

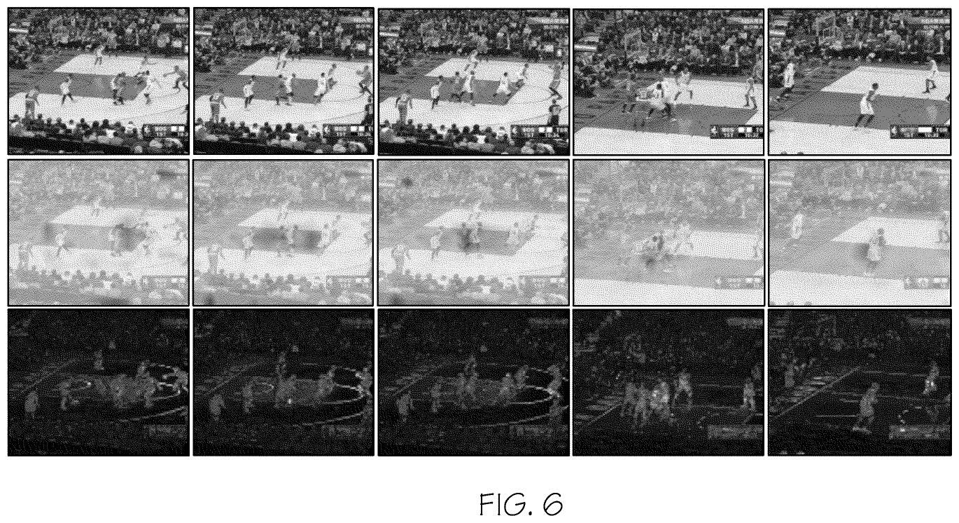

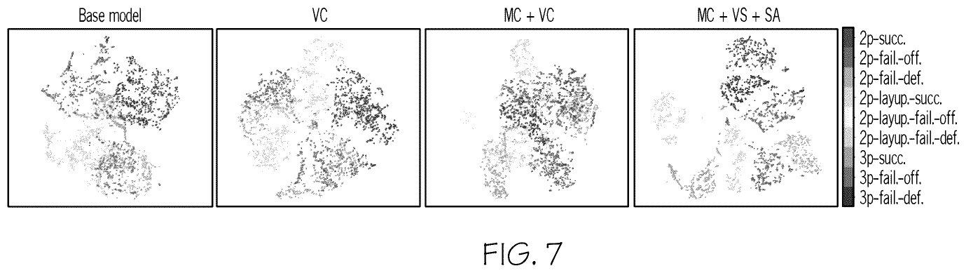

Applicant shows the attention visualization derived from the final Transformer encoder layer on the NBA dataset in FIG. 6. The results indicate that the model learnt to pay attention to essential concepts, such as the position of the players, and to follow the activity in a specific video clip. The t-SNE visualization results of Applicant's model and its modifications are shown in FIG. 7. Each model's final group representation on NBA is shown in two-dimensional space. The recommended modules help to clearly separate each class.

### Example 1.13. Conclusion

Applicant's work introduces SPARTAN, a self-supervised video transformer-based model. The approach involves generating multiple spatio-temporally varying views from a single video at different scales and frame rates. Two sets of correspondence learning tasks are then defined to capture the motion properties and cross-view relationships between the sampled clips. The self-supervised objective involves reconstructing one view from the other in the latent space of teacher and student networks. Moreover, Applicant's SPARTAN can model long-range spatio-temporal dependencies and perform dynamic inference within a single architecture. Applicant evaluated SPARTAN on two group activity recognition benchmarks and find that it outperforms the current state-of-the-art models.

Without further elaboration, it is believed that one skilled in the art can, using the description herein, utilize the present disclosure to its fullest extent. The embodiments described herein are to be construed as illustrative and not as constraining the remainder of the disclosure in any way whatsoever. While the embodiments have been shown and described, many variations and modifications thereof can be made by one skilled in the art without departing from the spirit and teachings of the invention. Accordingly, the scope of protection is not limited by the description set out above, but is only limited by the claims, including all equivalents of the subject matter of the claims. The disclosures of all patents, patent applications and publications cited herein are hereby incorporated herein by reference, to the extent that they provide procedural or other details consistent with and supplementary to those set forth herein

1. A computer-implemented method of predicting one or more motions of a video, said method comprising:
(a) generating a plurality of temporal views of the video, wherein the temporal views of the video comprise a plurality of different video clips with varying motion characteristics;
(b) varying spatial characteristics of the plurality of the video clips, wherein the varying comprises generating local spatial fields and global spatial fields of the video clips; and
(c) feeding the video clips, the local spatial fields, and the global spatial fields into an algorithm, wherein the algorithm matches varying views of the video clips across spatial and temporal dimensions in latent space to predict the one or motions of the video.

2. The method of claim 1, further comprising a step of generating an output of the one or more predicted motions of the video.

3. The method of claim 1, wherein the temporal views of the video comprise a collection of video clips sampled at a certain video frame rate.

4. The method of claim 1, wherein the algorithm comprises a loss of function algorithm.

5. The method of claim 1, wherein the algorithm comprises an artificial neural network.

6. The method of claim 1, wherein the prediction occurs in a self-supervised manner.

7. The method of claim 1, wherein the prediction occurs without the use of ground-truth bounding boxes.

8. The method of claim 1, wherein the prediction occurs without the use of labeled data sets.

9. The method of claim 1, wherein the prediction occurs without the use of object detectors.

10. The method of claim 1, wherein the method is utilized for group activity recognition (GAR), video analysis, video monitoring, interpretation of social settings, training, sport-related training, or combinations thereof.

11. A computer program product for predicting one or more motions of a video, wherein the computer program product comprises one or more computer readable storage mediums having program code embodied therewith, and wherein the program code comprises programming instructions for:
(a) generating a plurality of temporal views of the video, wherein the temporal views of the video comprise a plurality of different video clips with varying motion characteristics;
(b) varying spatial characteristics of the plurality of the video clips, wherein the varying comprises generating local spatial fields and global spatial fields of the video clips; and
(c) feeding the video clips, the local spatial fields, and the global spatial fields into an algorithm, wherein the algorithm matches varying views of the video clips across spatial and temporal dimensions in latent space to predict the one or motions of the video.

12. The computer program product of claim 11, wherein the program code further comprises programming instructions for generating an output of the one or more predicted motions of the video.

13. The computer program product of claim 11, wherein the computer program product further comprises the algorithm.

14. The computer program product of claim 11, wherein the algorithm comprises a loss of function algorithm.

15. The computer program product of claim 11, wherein the algorithm comprises an artificial neural network.

16. A system, comprising:
a memory for storing a computer program for predicting one or more motions of a video; and
a processor connected to said memory, wherein said processor is configured to execute program instructions of the computer program comprising:
(a) generating a plurality of temporal views of the video, wherein the temporal views of the video comprise a plurality of different video clips with varying motion characteristics;
(b) varying spatial characteristics of the plurality of the video clips, wherein the varying comprises generating local spatial fields and global spatial fields of the video clips; and
(c) feeding the video clips, the local spatial fields, and the global spatial fields into an algorithm, wherein the algorithm matches varying views of the video clips across spatial and temporal dimensions in latent space to predict the one or motions of the video.

17. The system of claim 16, wherein the processor is further configured to execute program instructions for generating an output of the one or more predicted motions of the video.

18. The system of claim 16, wherein the system further comprises the algorithm.

19. The system of claim 16, wherein the algorithm comprises a loss of function algorithm.

20. The system of claim 16, wherein the algorithm comprises an artificial neural network.
